(19) United States
(12) Patent Application Publication
(10) Pub. No.: US 2007/0236175 A1
(43) Pub. Date: Oct. 11, 2007

(54) COMBINATION BATTERY CHARGER

(75) Inventor: David Wei, Taipei (TW)

Correspondence Address: PAI PATENT & TRADEMARK LAW FIRM, 1001 FOURTH AVENUE, SUITE 3200, SEATTLE, WA, 98154, US

(73) Assignee: E-BENK TECH CO., LTD., Taipei County (TW)

(21) Appl. No.: 11/308,549

(22) Filed: Apr. 6, 2006

(51) Int. Cl. H02J 7/00

(52) U.S. Cl. 320/114

(57) ABSTRACT

A combination battery charger is disclosed to include a housing, a first electric plug pivoted to the housing for connection to the electric socket for cigarette lighter of a motor vehicle and turnable in and out of a first outside open chamber of the housing within the range of 0 to 180° to fit different installation angles, a second electric plug pivoted to the housing for connection to a city power supply outlet and turnable in and out of a second outside open chamber of the housing, and a charging circuit board mounted inside the housing and electrically connected to the first electric plug and the second electric plug for converting city power supply/car battery power supply into a charging power supply for charging a battery being inserted into a third outside open chamber of the housing and set into contact with metal contacts of the charging circuit board that are suspended in the third outside open chamber.

### BACKGROUND OF THE INVENTION

1. Field of the Invention

The present invention relates to a battery charger and more particularly to a combination battery charger that can be selectively connected to the electric socket for cigarette lighter of a motor vehicle or a city electric power outlet for charging a battery.

2. Description of the Related Art

As the general public is increasingly conscious of environmental protection, rechargeable battery cells are intensively used in a variety of electric and electronic products to substitute conventional non-rechargeable battery cells. However, when the power of a rechargeable battery cell is low, a battery charger must be used to charge the rechargeable battery cell to the saturated status for it to work again.

Commercial battery chargers commonly have a power input side specifically designed for connection to the electric socket for cigarette lighter of a motor vehicle or a city electric power outlet. However, a battery charger designed for connection to the electric socket for cigarette lighter is not connectable to a city electric power outlet, and a battery charger designed for connection to a city electric power outlet is not connectable to the electric socket for cigarette lighter. Therefore, the application of conventional battery chargers is limited. Further, conventional battery chargers for use in automobiles commonly have a cable with an electric plug for connection to the electric socket for cigarette lighter. There are also knob battery chargers for use in automobiles that have the electric plug fixedly provided on the outside of the base of the battery charger. However, a battery charger of this design is not applicable to some vehicles because the angular position of the electric plug is not adjustable.

### SUMMARY OF THE INVENTION

The present invention has been accomplished under the circumstances in view. It is the main object of the present invention to provide a combination battery charger, which is connectable to the electric socket for cigarette lighter of a motor vehicle as well as a city electric power outlet. It is another object of the present invention to provide a combination battery charger, which fits the angular position of the electric socket for cigarette lighter of any of a variety of motor vehicles.

To achieve these and other objects of the present invention, the combination battery charger comprises a housing, the housing having a first outside open chamber, a second outside open chamber, and a third outside open chamber for receiving a battery for charging; a first electric plug pivoted to the housing for connection to the electric socket for cigarette lighter of a motor vehicle and turnable relative to the housing in and out of the first outside open chamber; a second electric plug pivoted to the housing for connection to a city power supply outlet and turnable relative to the housing in and out of the second outside open chamber; and a charging circuit board fixedly mounted inside the housing and electrically connected to the first electric plug and the second electric plug for converting city power supply/car battery power supply into a charging power supply for charging a battery, the charging circuit board having a set of metal contacts extending out of the housing and suspended in the third outside open chamber for the contact of the battery being inserted into the third outside open chamber.

### BRIEF DESCRIPTION OF THE DRAWINGS

FIG. 1 is an exploded view of a combination battery charger according to the present invention.

FIG. 2 is an oblique top view of the combination battery charger according to the present invention.

FIG. 3 is an oblique bottom view of the combination battery charger according to the present invention.

### DETAILED DESCRIPTION OF THE PREFERRED EMBODIMENT

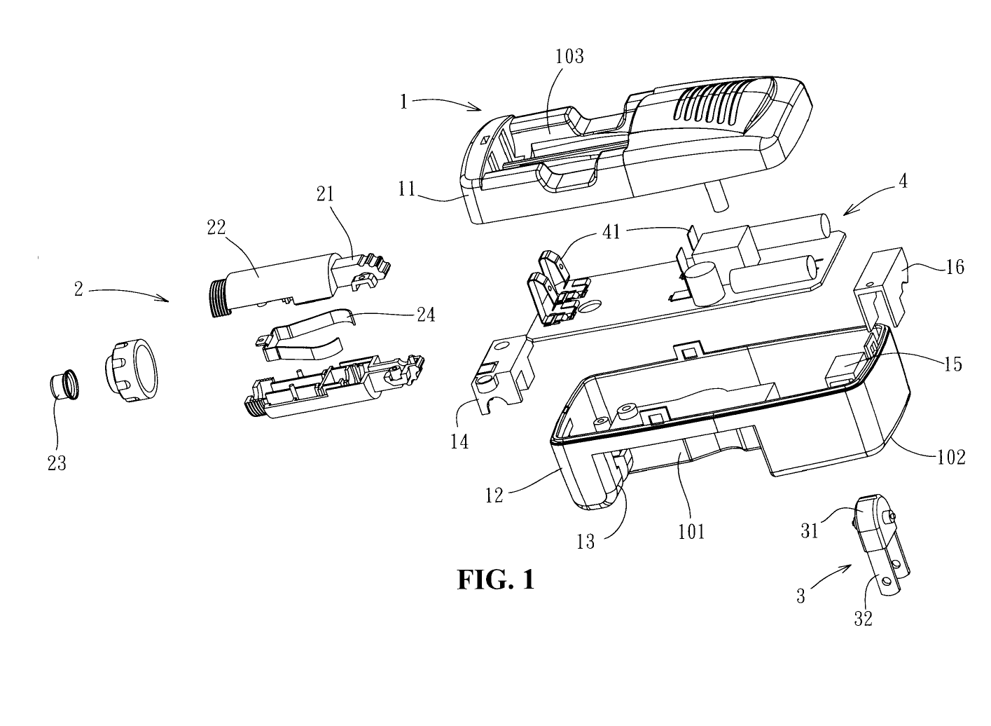

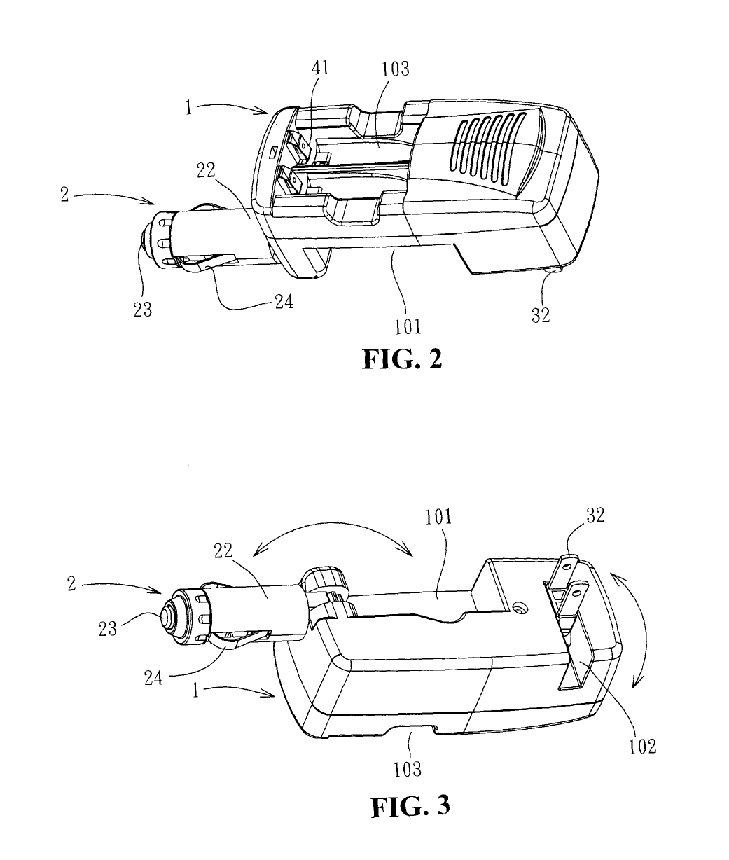

Referring to FIGS. 1˜3, a combination battery charger in accordance with the present invention is shown comprising a housing 1, a first electric plug 2, a second electric plug 3, and a charging circuit board 4.

The housing 1 comprises an upper cover shell 11 and a bottom cover shell 12. The upper cover shell 11 and the bottom cover shell 12 are fixedly abutted against each other, defining an inside accommodation space. Formed on the outside wall of the housing 1 are a first recessed chamber 101, a second recessed chamber 102, and a third recessed chamber 103. The housing 1 further has a first seat 13 provided in one end of the first recessed chamber 101, a first pivot holder 14 affixed to the first seat 13, a second seat 15 provided in one end of the second recessed chamber 102, and a second pivot holder 16 affixed to the second seat 15.

The first electric plug 2 comprises a pivot shaft 21 pivotally connected to the first pivot holder 14, a plug shell 22 extending from one end of the pivot shaft 21 remote from the first pivot holder 14 and insertable into the electric socket for cigarette lighter of any of a variety of motor vehicles, a positive electrode 23 affixed to the plug shell 22 and electrically connected to the charging circuit board 4 for contacting the positive electrode of the electric socket for cigarette lighter into which the first electric plug 2 is inserted, and a negative electrode 24 affixed to the plug shell 22 and electrically connected to the charging circuit board 4 for contacting the negative electrode of the electric socket for cigarette lighter into which the first electric plug 2 is inserted. After connection of the first electric plug 2 to the first pivot holder 14, the user can turn the first electric plug 2 in and out of the first recessed chamber 101.

The second electric plug 3 has a plug shell 31 pivotally connected to the second pivot holder 16, and a plurality of metal blades 32 affixed to the plug shell 31 and electrically connected to the charging circuit board 4 for insertion into a city electric power outlet. After connection of the second electric plug 3 to the second pivot holder 16, the user can turn the second electric plug 3 in and out of the second recessed chamber 102.

The charging circuit board 4 is mounted inside the housing 1, having a set of metal contacts 41 suspended in the third recessed chamber 103 for contacting the metal contacts of the battery cell to be recharged. Further, the charging circuit board 4 is electrically connected to the electrodes 23 and 24 of the first electric plug 2 and the metal blades 32 of the second electric plug 3. After insertion of the first electric plug 2 into the electric socket for cigarette lighter of a motor vehicle or the second electric plug 3 into a city electric power outlet, the charging circuit board 4 converts input power into designed voltage and current for output through the metal contacts 41 to charge the rechargeable battery cell that is inserted into the third recessed chamber 103 and kept in contact with the metal contacts 41 electrically.

When using the combination battery charger inside a house, turn the first electric plug 2 into the inside of the first recessed chamber 101 and then turn the second electric plug 3 out of the second recessed chamber 102, and then insert the metal blades 32 of the second electric plug 3 into a city electric power outlet to obtain city power supply which is converted by the charging circuit board 4 into the designed charging power for output through the metal contacts 41 to charge the rechargeable battery cell. On the contrary, when using the combination battery charger in a motor vehicle, turn the second electric plug 3 into the inside of the second recessed chamber 102 and then turn the first electric plug 2 out of the first recessed chamber 101, and then insert the plug shell 22 of the first electric plug 2 into the electric socket for cigarette lighter of the motor vehicle to obtain car battery power supply for processing by the charging circuit board 4 into the designed charging power for output through the metal contacts 41 to charge the rechargeable battery cell. Further, the first electric plug 2 can be turned in and out of the first recessed chamber 101 within the range of 0 to 180° to fit different installation angles.

A prototype of combination battery charger has been constructed with the features of FIGS. 1˜3. The combination battery charger functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A combination battery charger comprising:
a housing, said housing having a first outside open chamber, a second outside open chamber, and a third outside open chamber for receiving a battery for charging;
a first electric plug pivoted to said housing for connection to the electric socket for cigarette lighter of a motor vehicle and turnable relative to said housing in and out of said first outside open chamber;
a second electric plug pivoted to said housing for connection to a city power supply outlet and turnable relative to said housing in and out of said second outside open chamber; and
a charging circuit board fixedly mounted inside said housing and electrically connected to said first electric plug and said second electric plug for converting electric power from the first electric plug or from the second electric plug into a charging power supply for charging a battery, said charging circuit board having a set of metal contacts extending out of said housing and suspended in said third outside open chamber for contacting the battery being inserted into said third outside open chamber.

2. The combination battery charger as claimed in claim 1, wherein said housing comprises an upper cover shell and a bottom cover shell.

3. The combination battery charger as claimed in claim 1, wherein said housing comprises a first pivot holder mounted in one end of said first outside open chamber; said first electric plug comprises a pivot shaft pivotally connected to said first pivot holder, a plug shell extending from one end of said pivot shaft remote from said first pivot holder and insertable into the electric socket for cigarette lighter of a motor vehicle, a positive electrode affixed to said plug shell and electrically connected to said charging circuit board for contacting the positive electrode of the electric socket for cigarette lighter into which said first electric plug is inserted, and a negative electrode affixed to said plug shell and electrically connected to said charging circuit board for contacting the negative electrode of the electric socket for cigarette lighter into which said first electric plug is inserted.

4. The combination battery charger as claimed in claim 3, wherein said housing further comprises a second pivot holder mounted in one end of said second outside open chamber; said second electric plug comprises a plug shell pivotally connected to said second pivot holder, and a plurality of metal blades affixed to the plug shell of said second electric plug and electrically connected to said charging circuit board for insertion into a city electric power outlet.
